(19) United States
(12) Patent Application Publication
(10) Pub. No.: US 2011/0090725 A1
(43) Pub. Date: Apr. 21, 2011

(54) Systems and Methods of Synchronous Rectifier Control

(75) Inventor: Bing Lu, Manchester, NH (US)

(73) Assignee: Texas Instruments Inc, Dallas, TX (US)

(21) Appl. No.: 12/582,666

(22) Filed: Oct. 20, 2009

(51) Int. Cl. H02M 7/217

(52) U.S. Cl. 363/127

(57) ABSTRACT

Systems and methods for synchronous rectifier control are provided. A synchronous rectifier includes parasitic drain inductance and parasitic source inductance. Compensation inductance is introduced to offset the effects of parasitic inductance. Compensation inductance may be formed from the trace inductance on the semiconductor die. In certain semiconductor packages, the parasitic inductance may be substantially fixed such that the layout can be modified to generate fixed compensation inductance.

### TECHNICAL FIELD

The present disclosure is generally related to electronics and, more particularly, is related to switching devices.

### BACKGROUND

Synchronous rectification is a technique for improving efficiency of power converters in power electronics. It preferably consists of connecting a diode and a transistor (usually a power MOSFET) in parallel. When the diode is forward-biased, the transistor is turned on to reduce the voltage drop. When the diode is reverse-biased, the transistor is turned off, so no charge can flow through the circuit. This way, a rectifying characteristic is obtained, without the forward voltage drop associated with diodes in the on-state.

In low output voltage converters, the voltage drop of a diode (typically around 1 volt for a silicon diode at its rated current) has a very negative effect on efficiency. One classic solution consists of using Schottky diodes, which exhibit very low voltage drops (as low as 0.3 volts). However, when addressing very low-voltage converters, such as the buck converters that deliver power to the CPU of a computer (voltage is around 1 volt), this is no longer an adequate solution for good efficiency.

On the other hand, the transistors used in these very low-voltage converters are usually MOSFETs. These transistors behave like a resistor, so providing their resistance is low enough (for example by paralleling several devices), their voltage drop can be very low. Furthermore, MOSFETs have an intrinsic diode between their source and drain terminals. This makes these transistors useful for synchronous rectification: They can directly replace the rectifying diode in converters. They behave inherently like a diode, and when they are turned on (via a control circuit), they behave as a low value resistance, yielding lower losses.

### SUMMARY

Example embodiments of the present disclosure provide systems and methods of synchronous rectifier control. Briefly described, in architecture, one example embodiment of the system, among others, can be implemented as follows: a semiconductor die; and packaging for the semiconductor die, the packaging comprising compensation inductance configured to compensate for parasitic packaging inductance.

Embodiments of the present disclosure can also be viewed as providing methods for synchronous rectifier control. In this regard, one embodiment of such a method, among others, can be broadly summarized by the following: determining a first voltage across a semiconductor device, where the voltage across the device comprises the effects of parasitic inductance; determining a second voltage across the semiconductor device without the effects of the parasitic inductance; determining a third voltage to compensate for the difference between the first voltage and the second voltage; determining a compensation inductance for generation of the third voltage; and applying the compensation inductance to the semiconductor device.

### BRIEF DESCRIPTION OF THE DRAWINGS

FIG. 1 is a circuit diagram of an example embodiment of switch mode power supply with a synchronous rectifier in a flyback converter topology.

FIG. 2 is a timing diagram of an example embodiment of the switch mode power supply circuit of FIG. 1 in discontinuous conduction mode.

FIG. 3 is a circuit diagram of an example embodiment of a synchronous rectifier.

FIG. 4 is a timing diagram of an example embodiment of the current through the synchronous rectifier of FIG. 3.

FIG. 5 is a timing diagram of an example embodiment of the voltages across the synchronous rectifier of FIG. 3.

FIG. 6 is a circuit diagram of an example embodiment of a system of synchronous rectifier control.

FIG. 7 is a circuit diagram of an example embodiment of an implantation circuit of the system of synchronous rectifier control of FIG. 8.

FIG. 8 is a timing diagram of an example embodiment of the current through the synchronous rectifier of FIG. 6.

FIG. 9 is a timing diagram of an example embodiment of the voltages across the synchronous rectifier of FIG. 6.

FIG. 10 is a flow diagram of a method of synchronous rectifier control.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

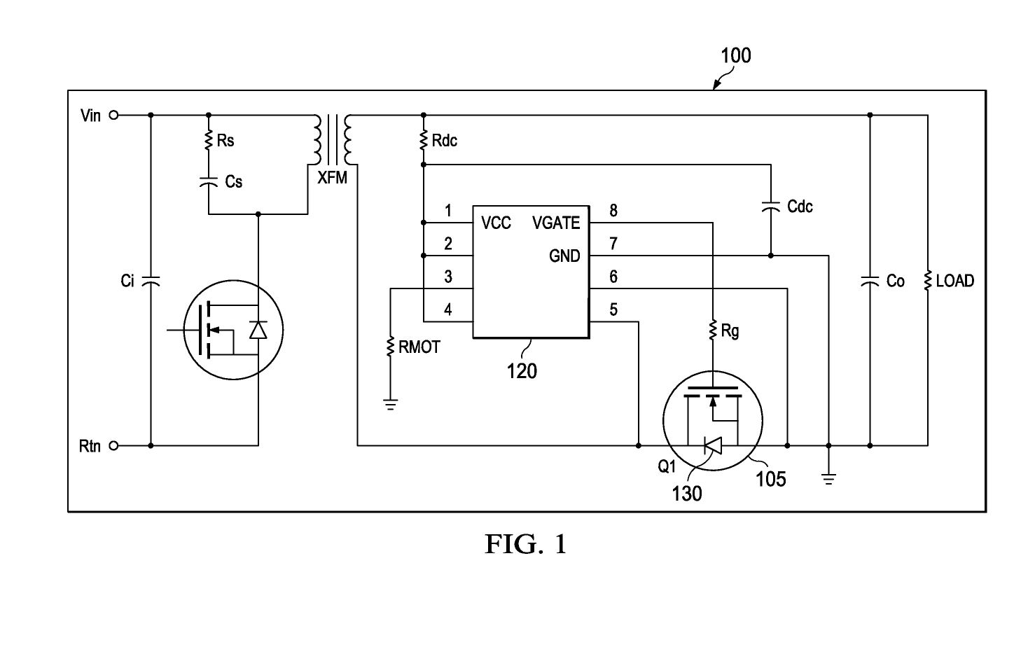

An example embodiment of a system of synchronous rectifier control may be used in an LLC resonant converter or a flyback converter, as non-limiting examples. In these two example topologies, the diode current enters the discontinuous current mode (DCM) condition for a large part of the switching period. In an LLC resonant converter, or in a flyback converter such as the converter of FIG. 1, to achieve high efficiency for low output voltage applications, it may be preferable to use synchronous rectifier (SR) 105 to reduce conduction losses.

The transition from diodes to synchronous-rectification (SR) MOSFETs in secondary circuits of flyback converters increases with each new generation of MOSFETs, improving performance at little or no cost penalty. SR MOSFETs can be more efficient than diodes, allowing lower operating temperatures and smaller heat sinks, or no heat sinks at all. However, they require a control circuit to manage their switching behavior in order to emulate a diode. The usual synchronous rectifier control method in today's commercial power supplies involves deriving the logic signal for the controller from the secondary of a current transformer.

Traditionally, flyback converters were well suited for applications requiring power levels less than 150 W. Their major appeal was simplicity and low cost. Beyond 150 W, and certainly at power levels of 200 W and beyond, the half-bridge- and forward-converter were the standard topologies. The major problem with flyback converters, whether they were implemented with diodes or SR MOSFETs, was semiconductor conduction losses.

As with all isolating power-converter topologies, flyback converters employ a transformer on the secondary, on which resides a rectifier. The simplest configuration uses a half-wave rectifier diode on either the high or low side. Synchronous rectification combines a MOSFET with a controller for turning the device on or off so that it emulates the diode commutation of the ac from the transformer. The synchronous approach provides greater efficiency, albeit with a corresponding tradeoff in complexity and cost.

For a diode, the forward-conduction power loss is simply the product of the forward voltage and current. For a MOSFET, it's I²R_{DS(ON)}. When a diode has a standard 0.6-V V_{F}, a 4 A current turns 2.4 W into heat. And, if a MOSFET's R_{DS(ON)}=10 mΩ, the loss at 4 A is 0.16 W.

At 4 A, the MOSFET dissipates 93% less power, leading to a lower junction and case temperature, meaning that it requires either a smaller heat sink or no heat sink at all. Theoretically, for the diode and MOSFET characteristics in the example, power-loss parity doesn't occur until current reaches 60 A. In practice, long before you reach power-loss parity in a real circuit, you would choose a MOSFET with a lower RDS(ON), parallel a pair of devices, or choose a different architecture.

Though SR brings significant efficiency and thermal-management advantages over diode rectification, those advantages don't come for free: A gate-control signal is used to properly operate the FET. A popular approach to gate control uses a current transformer, a comparator, and a gate-driver stage. A simplified schematic of this arrangement appears in FIG. 1.

The current transformer senses the secondary current, imposing scaled copy on its load impedance, which results in a voltage proportional to the current, preserving the polarity information. The comparator detects this voltage and turns on the MOSFET through the driver when the secondary current conducts in the forward direction.

Delays through the current transformer and further delays due to parasitic capacitances at the comparator inputs prevent this circuit from responding to the current-polarity change as quickly as the simplified schematic might suggest. A measurable lag occurs, therefore, between the current's zero crossing and the time when the driver shuts off the switch. During this interval, reverse current steals charge from the bus capacitor, reducing efficiency and increasing output ripple. Indeed any secondary circuit that allows reactive energy to slosh back and forth between the transformer and bus capacitor suffers in this way, so tight timing to the current's zero crossing is critical to a highly efficient secondary circuit.

Modes of operation for a flyback circuit differ mainly for the turn-off phase of the SR switch. On the other hand, the turn-on phase of the secondary switch, which corresponds to the turn-off phase of the primary-side switch, is identical. This makes possible a variety of converter control schemes, including fixed-frequency, quasi-resonant; variable-frequency; and fully resonant, actively clamped converters with switching frequencies as high as 500 kHz.

At the start of the SR FET's conduction phase, current begins to flow through its body diode, generating a negative drain-to-source voltage across it. The body diode maintains a higher voltage drop than that of the device's drain-source channel. Therefore, it triggers turn-on threshold voltage VTH2 (FIG. 3).

At that point, the control logic drives the MOSFET's gate on, which in turn causes the conduction voltage (VDS) to drop. Some ringing usually accompanies that voltage drop, and the ringing can trigger the input comparator to turn off. This can be dealt with by using an externally programmable minimum on-time (MOT) blanking period that maintains the power MOSFET in the on state for a minimum interval. The programmable MOT also limits the SR MOSFET's minimum duty cycle and, as a consequence, the maximum duty cycle of the primary-side switch.

The synchronous MOSFET's turn-on and turn-off behavior closely emulates the diode's function, due to the use of the same device as the sensing element. This approach obtains the highest possible performance for a given switch, often enabling the use of smaller switches. The control resolution of a discrete implementation is often insufficient to measure the current waveform close to its zero crossing, allowing the current to invert before switching off.

Once the SR MOSFET turns on, it remains on until the rectified current decays to the level at which the drain-to-source voltage (V_{DS}) crosses the turn-off threshold voltage V_{TH1}. How this action takes place depends on the mode of operation.

The systems and methods of synchronous rectifier control disclosed herein may be used on the turn-off side in example embodiments, although other implementations may also be covered by this disclosure. Parasitic inductances of the package and layout may cause the current to decrease and increase di/dt for both LLC and flyback applications among others. The voltage drop caused by the parasitic inductance and the high di/dt equivalently increases the turn-off threshold voltage. It also may cause SR 105 to turn off at higher current, increasing the conduction loss. The systems and methods of synchronous rectifier control disclosed herein compensate the voltage drop caused by the parasitic inductance and the high di/dt, decreasing the turn-off current and the conduction losses.

FIG. 1 provides circuit 100 of a flyback converter topology using synchronous rectifier 105. In an ideal (lossless) flyback converter, the input voltage, the transformer and the duty cycle of switch 105 determine the output voltage.

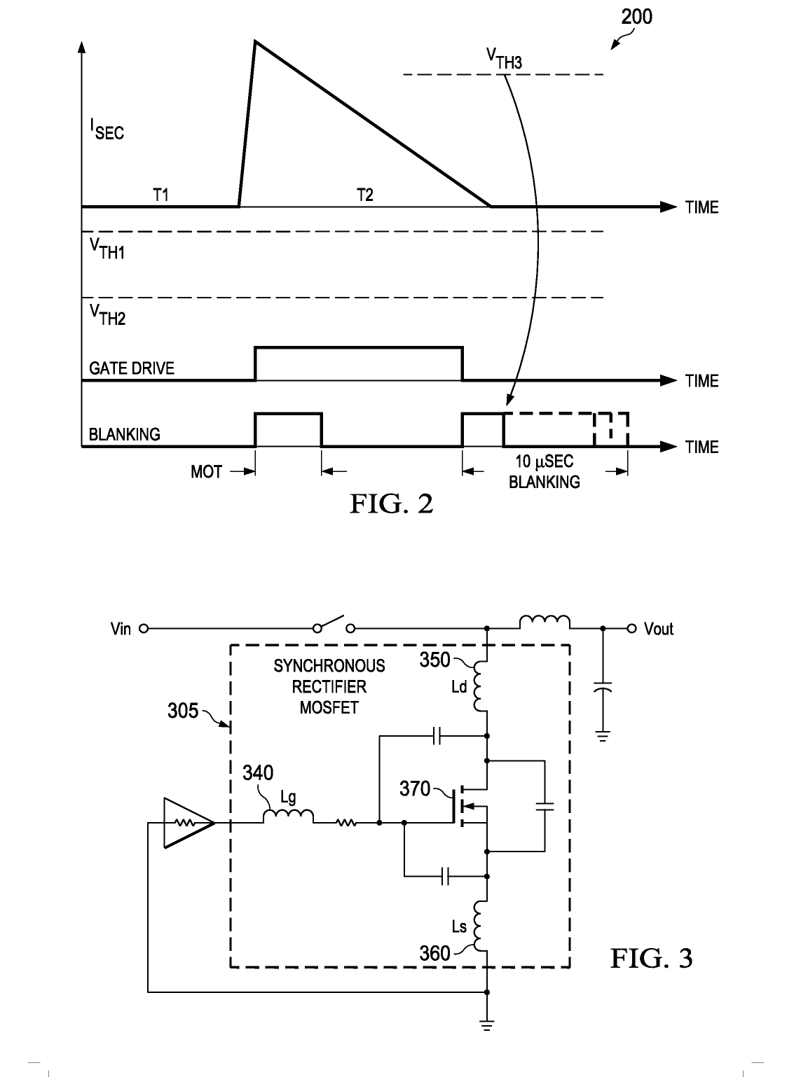

FIG. 2 provides timing diagram 200 which demonstrates the operation of circuit 100 for one switching cycle in discontinuous conduction mode (DCM). Once the current crosses the threshold, it once again flows through the body diode, causing a negative step in V_{DS}. Depending on the amount of residual current, V_{DS} might again trigger the turn-on threshold. To prevent this, an internally set blanking interval (t_{BLANK}) causes the controller to ignore this V_{TH2} crossing. As soon as V_{DS} crosses positive threshold V_{TH3}, this blanking time terminates, and the controller is ready for the next conduction cycle.

The conduction time of SR 105 should be as long as possible so that the most of the conduction loss can be saved, while it shouldn't allow the current to flow negative. Otherwise, the output energy is transferred to the primary side and causes extra losses. The gate of SR 105 is generally determined by the voltage drop across SR 105.

When the voltage across SR105 (MOSFET drain to source voltage) changes from positive to negative, for example, to about −0.7V, body diode 130 of SR 105 changes from reverse biased to positive biased and becomes conducting. At this moment, SR 105 can be turned on. On this side, the control is simple, because of the −0.7V is easy to detect. Compared to several mV, 0.7V is a relatively high threshold and the voltage drop caused by the parasitic inductor won't have much effect.

After SR 105 is turned on, when the voltage across SR 105 becomes too small, for instance, several mVs, the current flowing through SR 105 is too small. If SR 105 remains ON, the current through SR 105 becomes negative and circuit 100 begins to transfer energy from the secondary side to the primary side, which causes high losses. The negative current also can be treated as the reverse recovery current of body diode 130, causing extra switching loss as well. Therefore, when the current is small, the converter turns off SR 105. On the other hand, it is preferable that the threshold voltage is as small as possible to minimize conduction loss. After SR 105 is turned off, SR 105 becomes a diode and turns off normally

In a synchronous converter, where devices are turned OFF and ON alternatively, the potential exists for both devices to be momentarily turned ON at the same time, leading to a high shoot through current from the input source to the ground return with likely catastrophic results. To prevent this, a turn OFF to turn ON delay is added to the gate drive signals.

Since the nature of low voltage converters leads to the use of low gate threshold metal oxide semiconductor field effect transistors (MOSFETS) in example embodiments, synchronous rectifier 105 should not be turned ON inadvertently. High dv/dt when synchronous rectifier 105 is turned OFF can raise the voltage on the gate of synchronous rectifier 105 through capacitive coupling from the drain to gate to the point where synchronous rectifier 105 is momentarily turned ON. FIG. 3 provides a circuit diagram of synchronous rectifier 305 with its parasitic elements. Synchronous rectifier 305 includes parasitic gate inductance 340, parasitic drain inductance 350, and parasitic source inductance 360. Focusing on parasitic drain inductance 350 and parasitic source inductance 360, these parasitic are attributed to the packaging and can't be eliminated. The di/dt on parasitic drain inductance 350 and parasitic source inductance 360 cause extra voltage drop across synchronous rectifier 305. This voltage drop may cause synchronous rectifier 305 to turn OFF early and generate additional conduction loss.

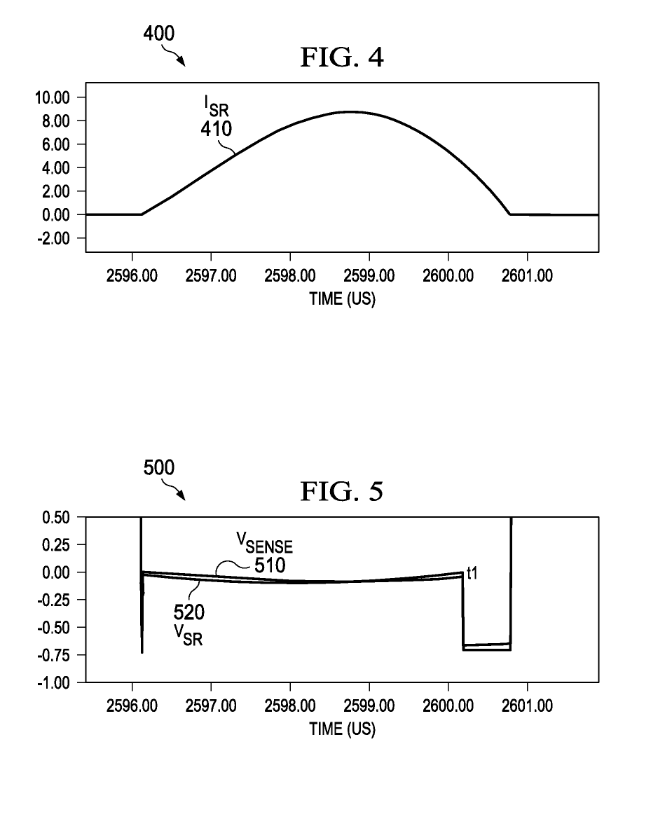

FIG. 4 provides graph 400 of the current through synchronous rectifier 305. FIG. 5 provides corresponding graph 500 of the voltage across synchronous rectifier 305, parasitic drain inductance 350, and parasitic source inductance 360 and the voltage across synchronous rectifier 305 itself. The early turnoff is demonstrated at t1 and can be attributed to the effects of parasitic drain inductance 350 and parasitic source inductance 360.

Waveform I_{SR} 410 provides the current through synchronous rectifier 305. Waveform V_{SENSE} 510 provides the voltage across synchronous rectifier 305 and waveform V_{SR} provides the voltage across MOSFET 370.

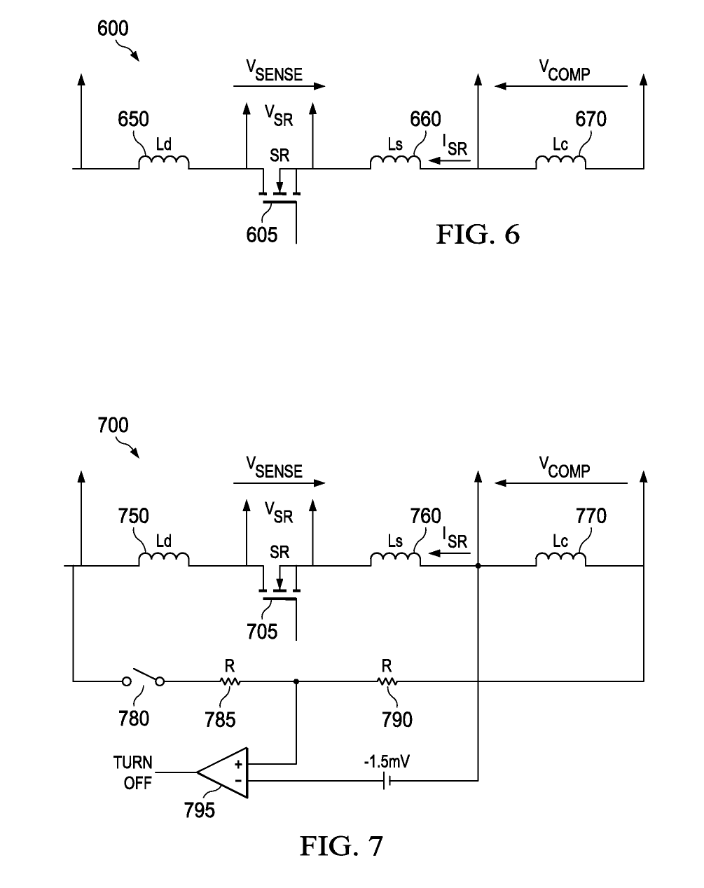

FIG. 6 provides circuit diagram 600 of an example embodiment of a system of synchronous rectifier control. As in the circuit diagram of FIG. 3, synchronous rectifier 605 includes parasitic drain inductance 650 and parasitic source inductance 660. In this example embodiment, compensation inductance 670 is introduced to offset the effects of parasitic drain inductance 650 and parasitic source inductance 660. Compensation inductance 670 may be formed from the trace inductance on the semiconductor die or by external PCB traces. An external discrete inductor may also be used. In certain semiconductor packages, the parasitic inductance may be substantially fixed such that the layout can be modified to generate fixed compensation inductance 670.

To calculate the value of compensation inductance 670, L_{C},

V_{SENSE}=V_{SR}−(L_{D}+L_{S})dl_{SR}dt

V_{COMP}=L_{C}dl_{SR}dt

L_{C}=L_{D}+L_{S}→V_{COMP}+V_{SENSE}=V_{SR}

The closer compensation inductance 670 is to the synchronous rectifier 605, the lower the inductance. The further compensation inductance 670 is from synchronous rectifier 605, the higher the inductance. The value of compensation inductance 670 may be set by setting the location of compensation inductance 670 relative to synchronous rectifier 605, by setting the shape, such as non-limiting examples of rectangular, round, square, triangular, or even an incongruous shape. Example embodiments of systems and methods of synchronous rectifier control may set compensation inductance 670 by size, as well, such as setting the length and width of the trace. Example embodiments may set with one of the disclosed options or more than one of the options, and may use some other similar option.

FIG. 7 provides circuit 700 for implementing compensation inductance 770 into the package for synchronous rectifier 705. Compensation inductance 770 is sized, located, and/or shaped to compensate for parasitic drain inductance 750 and parasitic source inductance 760. V_{COMP} is compared to V_{SENSE} by comparator 795. V_{SENSE} is switched into the non-inverting input of comparator 795 after being divided by resistor divider compromising resistor 785 and resistor 790. The compensation inductance can also be calculated based on the existing packaging inductances. For instance, if using the circuit diagram of FIG. 7, the compensation inductor LC should be LD+LS. If the resistors in the circuit diagram are different, the inductance can be calculated based on the resistor ratio. The general concept is a electric bridge, and the ratio between the inductors should be equal to the ratio between the resistors.

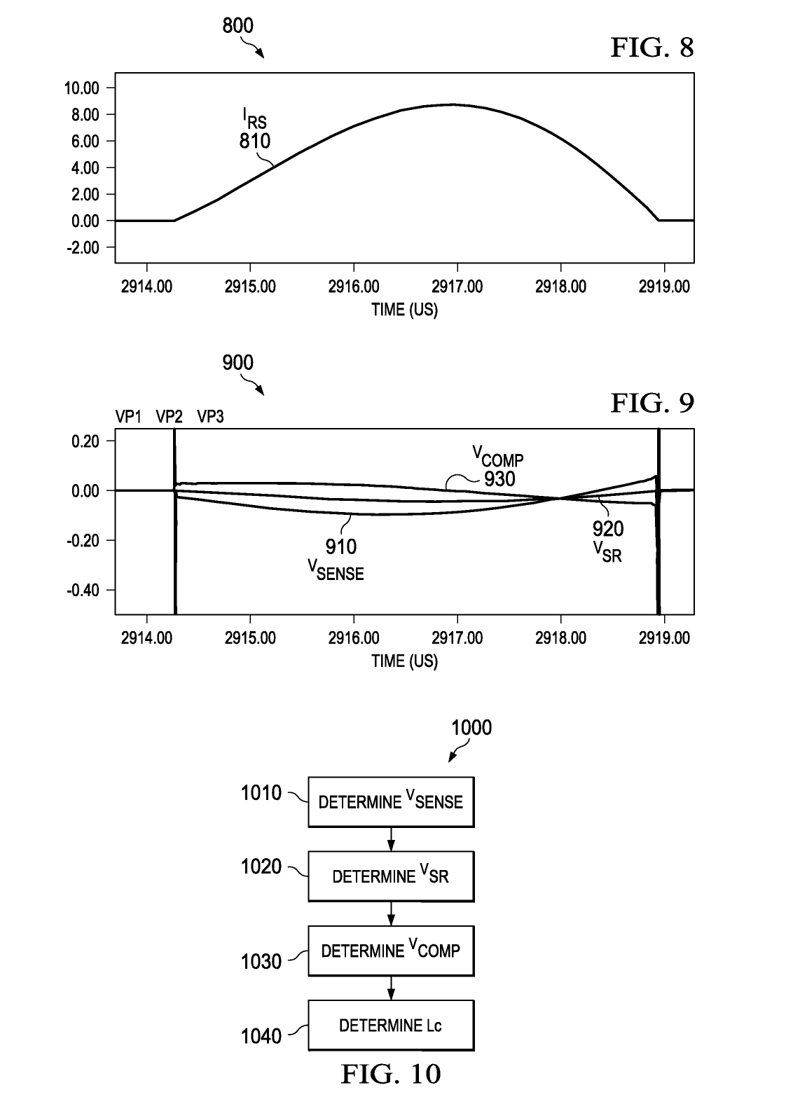

FIG. 8 provides graph 800 of the current through synchronous rectifier 605. FIG. 9 provides corresponding graph 900 of the voltage across synchronous rectifier 605, parasitic drain inductance 650, and parasitic source inductance 660 and the voltage across synchronous rectifier 605 itself. The early turnoff shown at t1 in FIG. 5 is no longer present and can be attributed to the effects of compensation inductance 670. Waveform I_{SR} 810 provides the current through synchronous rectifier 605. Waveform V_{SENSE} 910 provides the voltage across the packaged device including the parasitic inductances and the compensation inductances and waveform V_{SR} 920 provides the voltage across synchronous rectifier 605. Waveform V_{COMP} 920 provides the voltage across compensation inductance 670.

FIG. 10 provides flowchart 1000 of an example embodiment of a method of synchronous rectifier control. In block 1010, V_{SENSE}, the voltage across the parasitic drain inductance, the synchronous rectifier, and the parasitic source inductance, is determined. In block 1020, V_{SR}, the voltage across the synchronous rectifier is determined. In block 1030, V_{COMP}, the voltage across the compensation inductance is determined using V_{SENSE} and V_{SR}. In block 1040, LC, the compensation inductance, is determined from V_{COMP}.

Although the systems and methods disclosed herein are provided with an example synchronous rectifier device, the disclosed systems and methods would apply to any packaged semiconductor device that has parasitic drain inductance and parasitic source inductance. Moreover, the systems and methods disclosed herein would not only apply to MOSFET devices with parasitic source and drain inductances, but also to any device with parasitic inductance. Additionally, although the example circuit is a flyback converter, the systems and methods disclosed herein are applicable to many other circuit topologies and are intended to be included in this disclosure.

Therefore, at least the following is claimed:

1. A synchronous rectifier comprising:
a transistor on a semiconductor die; and
compensation inductance configured to compensate for parasitic drain inductance and parasitic source inductance introduced in packaging of the transistor.

2. The synchronous rectifier of claim 1, wherein the compensation inductance is external to packaging of the synchronous rectifier.

3. The synchronous rectifier of claim 1, wherein the compensation inductance comprises at least one of a trace on the semiconductor die or PCB traces.

4. The synchronous rectifier of claim 1, wherein the transistor comprises a metal oxide semiconductor field effect transistor (MOSFET).

5. The synchronous rectifier of claim 1, wherein the compensation inductance is located relative to the synchronous rectifier, the location affecting the compensation inductance.

6. The synchronous rectifier of claim 1, wherein the compensation inductance is configured by shape as at least one of a rectangle, a circle, a square, a triangle, a congruous shape, and an incongruous shape, the shape affecting the compensation inductance.

7. The synchronous rectifier of claim 1, wherein the compensation inductance is configured by size such that at least on of the length and width is configured, the size affecting the compensation inductance.

8. A system for compensating for parasitic inductance in a semiconductor device comprising:
a semiconductor die; and
packaging for the semiconductor die; and
compensation inductance configured to compensate for parasitic packaging inductance.

9. The system of claim 8, wherein the semiconductor die comprises a transistor.

10. The system of claim 9, wherein the transistor is a metal oxide semiconductor field effect transistor (MOSFET).

11. The system of claim 8, wherein the semiconductor die is a synchronous rectifier.

12. The system of claim 8, wherein the compensation inductance comprises trace inductance on the semiconductor die.

13. The system of claim 8, wherein the parasitic packaging inductance comprises source inductance and drain inductance.

14. The system of claim 8 wherein the compensation inductance is external to the packaging.

15. The system of claim 8, wherein the compensation inductance is located relative to the synchronous rectifier, the location affecting the compensation inductance.

16. The system of claim 8, wherein the compensation inductance is configured by shape as at least one of a rectangle, a circle, a square, a triangle, a congruous shape, and an incongruous shape, the shape affecting the compensation inductance.

17. The system of claim 8, wherein the compensation inductance is configured by size such that at least on of the length and width is configured, the size affecting the compensation inductance.

18. A method comprising:
determining a first voltage across a semiconductor device, where the voltage across the device comprises the effects of parasitic inductance;
determining a second voltage across the semiconductor device without the effects of the parasitic inductance;
determining a third voltage to compensate for the difference between the first voltage and the second voltage;
determining a compensation inductance for generation of the third voltage; and
applying the compensation inductance to the semiconductor device.

19. The method of claim 18, wherein the semiconductor device is a synchronous rectifier.

20. The method of claim 18, wherein the compensation inductance is configured by at least one of location relative to the synchronous rectifier, shape, and size, the location, shape, and size affecting the compensation inductance.
